(19) United States
(12) Patent Application Publication
(10) Pub. No.: US 2018/0017496 A1
(43) Pub. Date: Jan. 18, 2018

(54) Method for detecting dissolution rate of preparation containing colloidal bismuth pectin

(71) Applicant: SHANXI ZHENDONG ANTE BIOPHARMACEUTICAL CO., LTD., Jinzhong, Shanxi (CN)

(72) Inventors: Anping Li, Jinzhong (CN); Feng Cui, Jinzhong (CN); Ping Zhu, Jinzhong (CN); Zhengguo Qin, Jinzhong (CN); Tai Zheng, Jinzhong (CN); Yuexia Wu, Jinzhong (CN)

(21) Appl. No.: 15/548,095

(22) PCT Filed: May 27, 2016
(86) PCT No.: PCT/CN2016/083740

§ 371 Date: Aug. 2, 2017

(30) Foreign Application Priority Data
Jun. 23, 2015 (CN) 201510348307.5

(51) Int. Cl. G01N 21/78; G01N 15/06

(52) U.S. Cl. CPC G01N 21/78; G01N 15/06; G01N 2015/0693

(57) ABSTRACT

A method for detecting a dissolution rate of a preparation containing colloidal bismuth pectin includes steps of: according to “Pharmacopoeia of the People's Republic of China, 2010 Edition, Volume 2, Appendix XC”, dispersing the preparation containing the colloidal bismuth pectin into dissolution medium, and directly obtaining dissolution liquid; adding a protonic acid dissociation agent into the dissolution liquid until a hydrogen ion concentration reaches 0.8-1.2 mol/L; centrifuging for separating a supernatant; coloring the supernatant by adding a chromogen solution of citric acid or ascorbic acid and potassium iodide to obtain a test solution; calculating a dissolution amount, which is accounted by bismuth, of the colloidal bismuth pectin with a spectrophotometry method. The method of the present invention well detects dissolution curves and rates of the colloidal bismuth pectin in the preparation thereof, satisfying quality control requirements.

### CROSS REFERENCE OF RELATED APPLICATION

This is a U.S. National Stage under 35 U.S.C. 371 of the International Application PCT/CN2016/083740, filed May 27, 2016, which claims priority under 35 U.S.C. 119(a-d) to CN 201510348307.5, filed Jun. 23, 2015.

### BACKGROUND OF THE PRESENT INVENTION

### Field of Invention

The present invention relates to a method for detecting a dissolution rate, and more particularly to a method for detecting a dissolution rate of a preparation containing colloidal bismuth pectin.

### Description of Related Arts

The colloidal bismuth pectin is a compound of uncertain constitution of the pectin and the bismuth Bi, which is yellow powder; wherein the bismuth pectin content (takes bismuth for calculation) is 14.0%-16.0%; pH is 8.5-10.5; the sedimentation rate is 1-0.97. The colloidal bismuth pectin is insoluble in ethanol, acetone, ether and other organic solvents, which is able to disperse uniformly and form stable colloidal system in the water.

The colloidal bismuth pectin substitutes small molecule acid groups with biological macromolecules pectin. Compared with other bismuth preparations such as bismuth subgallate, bismuth subnitrate, bismuth subsalicylate and bismuth potassium cirtrate, the colloidal bismuth pectin has strong colloidal characters, high viscosity and low absorption by human body. The colloidal pectin bismuth has high affinity for ulcerated mucosa, which forms chelation with the ulcer mucoprotein by bismuth to cover on the gastric mucosa. The epithelial tissues are stimulated to discharge mucus and the pepsin activity is inhibited to protect the gastric mucosa. The bismuth is able to kill the Helicobacter pylori. Compared to the conventional medicine, the colloidal bismuth pectin has strong protection for mucosa, which widely applied in the treatment of intestinal tract disease including peptic ulcer disease, chronic gastritis and etc.

The colloidal bismuth pectin and the capsule preparation is an original ground medicine manufactured by the Taiyuan Red Star Pharmacy Plant which is the predecessor of Shanxi Zhendong Ante Biopharmaceutical Co., Ltd. The medicine gets the new drug certification and the drug production license from the Ministry of Health of the People's Republic of China in 1992 and now is listed in the Pharmacopoeia of the People's Republic of China, 2^{nd} volume of the 2010 version. There is no dissolution detection event for the colloidal bismuth pectin preparations.

Quality of oral solid preparation is influenced by formulation design, preparation process, storage conditions and other factors, wherein dissolution and absorption processes determine its effectiveness. Dissolution and disintegration time limit are important indicators of a solid preparation control, but relying only on disintegration time limit test as a measure standard is clearly not perfect. Disintegration time limit is only the initial stage of drug dissolution, and subsequent dispersion and dissolution processes will not be reflected by disintegrating time limit test. However, dissolution test covers disintegration, dispersion and dissolution processes, so it is more important to study dissolution of solid preparations.

Colloidal bismuth pectin is a complex consists of biological macromolecules pectin and metal form bismuth, which is greatly different from generic drugs and is not easy to be absorbed by human body. However, a dissolution amount directly affects protection effect of the colloidal bismuth pectin on gastric mucosa and killing Helicobacter pylori. In addition, detection of the dissolution of colloidal bismuth pectin preparations can more objectively reflect the relationship and impacts between drug and excipients, which reflects impacts of formation process variations and storage conditions on pharmaceutical quality to ensure homogeneity, effectiveness and stability, and is of great significance.

However, the colloidal bismuth pectin formed by chelation of pectin and metal bismuth has very stable properties, colloid viscosity is high, and colloidal dispersion system is formed after dissolution in dissolution medium. Therefore, if dissolution is determined fully in accordance with “Pharmacopoeia of the People's Republic of China, 2010 Edition” combined with dissolution detection in Appendix XC, not only titration liquid is hardly consumed, but also the formed colloidal dispersion system has a great impact on judgment of complexometric titration end point, resulting in poor repeatability and low accuracy of the detection method. Furthermore, due to a size of a microporous membrane for filtering dissolution liquid is generally 200 nm-1 μm, recovery rate during dissolution detection is low. As a result, bismuth pectin dissolution rate of the preparation containing colloidal bismuth pectin can not be accurately measured, and the methods need to be improved.

### SUMMARY OF THE PRESENT INVENTION

An object of the present invention is to provide a method for detecting a dissolution rate of a preparation containing colloidal bismuth pectin, so as to detect a colloidal bismuth pectin dissolution rate of the preparation containing the colloidal bismuth pectin, in such a manner that a quality of the preparation containing the colloidal bismuth pectin is better controlled.

Accordingly, in order to accomplish the above objects, the present invention provides a method for detecting a dissolution rate of a preparation containing colloidal bismuth pectin, comprising steps of: according to “Pharmacopoeia of the People's Republic of China, 2010 Edition, Volume 2, Appendix XC”, dispersing the preparation containing the colloidal bismuth pectin into dissolution medium, dissolving for 3-120 min with a centrifuging rate of 30-150 r/min, and directly obtaining dissolution liquid; adding a protonic acid dissociation agent into the dissolution liquid until a hydrogen ion concentration reaches 0.8-1.2 mol/L; centrifuging after completely dissociation; separating a supernatant; coloring the supernatant by adding a chromogen solution of citric acid or ascorbic acid and potassium iodide to obtain a test solution; testing an absorbance of the test solution at a wavelength of 380-470 nm; comparing the absorbance of the test solution with an absorbance of a reference solution with a known bismuth concentration under same conditions; calculating a dissolution amount, which is accounted by bismuth, of the colloidal bismuth pectin; wherein the dissolution medium is water, a buffer solution with a pH of 1.0-10.0, or an acid solution.

Furthermore, according to the present invention, the buffer solution is an acetate buffer solution, a phthalate buffer solution, a phosphate buffer solution or a borate buffer solution, with a pH of 1.0-10.0; and the acid solution is a 0.005-0.1 mol/L hydrochloric acid solution.

According to the present invention, the dissolution detection method is a first method (Basket Apparatus), a second method (Paddle Apparatus) or a third method (Cup Apparatus) in the “Pharmacopoeia of the People's Republic of China, 2010Edition, Volume 2, Appendix XC”.

The protonic acid dissociation agent is nitric acid, hydrochloric acid or sulfuric acid. Preferably, the protonic acid dissociation agent is the nitric acid.

The dissolution liquid dissociated with the protonic acid is centrifuged for 5-15 min at 7000-10000 r/min. The dissociated polymeric pectin in the dissolution liquid is fully settled to form a bismuth test solution without disturbance, which fulfils test requirements of a spectrophotometry method.

According to the method of the present invention, the chromogen solution is a water solution or a 0.2-2 mol/L nitric acid solution of potassium iodide, in which citric acid or ascorbic acid is added.

Furthermore, the chromogen solution comprises the citric acid or the ascorbic acid of 0.5 wt %-10 wt %, and the potassium iodide of 2.5 wt %-25 wt %.

Preferably, the chromogen solution comprises the citric acid or the ascorbic acid of 2.5 wt %, and the potassium iodide of 12.5 wt %.

According to the method of the present invention, the reference solution of the bismuth with a suitable concentration is prepared by dissolving the bismuth in the nitric acid before being diluted with water and adding the chromogen solution.

Specifically, the bismuth content per 1 ml of the test solution or 1 ml of the reference solution of the bismuth is 0.1-50 μg. Preferably, the bismuth content per 1 ml of the test solution or 1 ml of the reference solution of the bismuth is 2-20 μg. More preferably, the bismuth content per 1 ml of the test solution or 1 ml of the reference solution of the bismuth is 5-12 μg.

A single-wavelength method is adopted for measurement of the bismuth content. Alternatively, a double-wavelength method may also be adopted to avoid disturbance.

Yellow bismuth potassium iodide generated by the bismuth and the potassium iodide has characteristic absorption spectroscopy at 399±2 nm(crest), 433±2 nm(trough), 463±2 nm(crest). When the single-wavelength method is adopted for measurement; detection wavelengths are any wavelength from 399 nm, 433 nm and 463 nm, preferably 463 nm.

When a double-wavelength method is adopted for measurement; detection wavelengths are any two wavelengths from 399 nm, 433 nm and 463 nm; wherein the content is calculated with absorbance difference. Preferably, a combination of 433 nm and 463 nm is chosen.

The method for detecting a dissolution rate of a preparation containing colloidal bismuth pectin is suitable for a single preparation or a compound preparation containing the colloidal bismuth pectin, comprising tablets, dispersible tablets, enteric-coated tablets, colon-enteric-coated tablets, capsules, soft capsules, enteric-coated capsules, colon-enteric-coated capsules, granules, dripping pills, microcapsules and dry suspension.

Colloidal bismuth pectin is a complex consists of biological macromolecules pectin and bismuth, a colloidal dispersion system is formed after dissolution in dissolution medium, and there is a huge difference between the colloidal bismuth pectin and basic bismuth gallate, basic bismuth nitrate, bismuth subsalicylate, bismuth potassium citrate as well as other small molecules. Therefore, after sampling dissolution liquid, the present invention directly adds proton acid for disaggregation treatment without filtering, in such a manner that metal form bismuth is separated from pectin. Then a high-speed centrifugation method is used, in such a manner that the pectin and excipients precipitate and are fully separated from bismuth.

Furthermore, the present invention takes the advantage of the characteristic reaction between bismuth and potassium iodide in acid medium, which forms yellow bismuth potassium iodide. Based on the reaction, the bismuth content measurement by the ultraviolet-visible spectrophotometry method is established, which is able to accurately measure the bismuth content in the dissolution liquid of the preparation containing the colloidal bismuth pectin.

The present invention provides the method for detecting the dissolution rate of the preparation containing the colloidal bismuth pectin based on characteristics of the colloidal bismuth pectin, wherein the method of the present has a high recovery rate and a good repeatability, in such a manner that dissolution curves and the dissolution rate of the preparation containing the colloidal bismuth pectin are sufficiently detected, so as to better ensure homogeneity, effectiveness and stability. The method of the present invention is able to be used to displace disintegration time limit test for more truly reflecting an intrinsic quality of the preparation, which is quite important for enhancing quality controllability of products and ensuring product quality.

### BRIEF DESCRIPTION OF THE DRAWINGS

FIG. 1 is dissolution rate curves of colloidal bismuth pectin capsules in water.

FIG. 1 is dissolution rate curves of colloidal bismuth pectin tablets in a phosphate buffer solution.

### DETAILED DESCRIPTION OF THE PREFERRED EMBODIMENT

Embodiment 1: colloidal bismuth pectin dispersible tablet (50 mg accounted by bismuth)

1) Preparation of a chromogen solution: placing 5 g ascorbic acid and 25 g potassium iodide in a 200 ml volumetric flask; adding 100 ml of water; shaking to dissolve; adding 25ml of a nitric acid solution of 1 mol/L; adding water to dilute; dripping water to meet a scale, so as to obtain the chromogen solution containing 2.5% of the ascorbic acid and 12.5% of potassium iodide.

2) Preparation of a reference solution of bismuth: placing 275 mg accurately weighed bismuth in a 100 ml volumetric flask; adding 6.4 ml nitric acid to dissolve the bismuth; diluting with water until a scale is reached, so as to obtain a standard bismuth stock solution; accurately weighing 2 ml of the standard bismuth stock solution to place in a 100 ml volumetric flask; diluting with a 1 mol/L nitric acid solution until a scale is reached, so as to obtain a solution containing about 55 μg bismuth per 1 ml as a standard bismuth solution; accurately weighing 5 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin dispersible tablet; according to a second method (paddle apparatus) of dissolution detection in “Pharmacopoeia of the People's Republic of China, 2010 Edition, Volume 2, Appendix XC”, using 900 ml water as dissolution medium, dissolving for 20 min with a rate of 100 r/min, and obtaining dissolution liquid; accurately weighing 5 ml to place in a 15 ml centrifugal tube; accurately adding 5 ml of 2 mol/L nitric acid solution; shaking for 10 minutes; centrifuging for 10 min at 8000 r/min; accurately measuring 5 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 2 mol/L nitric acid solution; shaking for 5 minutes; accurately measuring 5 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 463 nm, and calculating the colloidal bismuth pectin content accounted by the bismuth with an external standard method; comparing with a colloidal bismuth pectin nominal value of the colloidal bismuth pectin dispersible tablet for calculating a dissolution rate.

According to results, the dissolution rates of six colloidal bismuth pectin dispersible tablets are respectively 96.2%, 92.5%, 94.3%, 95.6%, 91.5%, and 93.3%; an average value is 94%.

Embodiment 2: colloidal bismuth pectin enteric-coated tablet (100 mg accounted by bismuth)

1) Preparation of a chromogen solution: placing 15 g citric acid and 50 g potassium iodide in a 200 ml volumetric flask; adding 100 ml of water; shaking to dissolve; adding 25 ml of a nitric acid solution of 2 mol/L; adding water to dilute; dripping water to meet a scale, so as to obtain the chromogen solution containing 7.5% of the citric acid and 25% of potassium iodide.

2) Preparation of a reference solution of bismuth: placing 275 mg accurately weighed bismuth in a 100 ml volumetric flask; adding 6.4 ml nitric acid to dissolve the bismuth; diluting with water until a scale is reached, so as to obtain a standard bismuth stock solution; weighing 2 ml of the standard bismuth stock solution to place in a 50 ml volumetric flask; diluting with a 1.2 mol/L nitric acid solution until a scale is reached, so as to obtain a solution containing about 110 m bismuth per 1 ml as a standard bismuth solution; accurately weighing 5 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin enteric-coated tablet; according to a first method (basket apparatus) of dissolution detection in “Pharmacopoeia of the People's Republic of China, 2010Edition, Volume 2, Appendix XC”, using 900 ml phosphate buffer solution with a pH of 6.8 as dissolution medium, dissolving for 60 min with a rate of 50 r/min, and obtaining dissolution liquid; accurately weighing 5 ml to place in a centrifugal tube; accurately adding 5 ml of 2.4 mol/L nitric acid solution; shaking for 5 minutes; centrifuging for 15 min at 7000 r/min; accurately measuring 5 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 2.4 mol/L nitric acid solution; shaking for 5 minutes; accurately measuring 5 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 399 nm, and calculating the colloidal bismuth pectin content accounted by the bismuth with an external standard method; comparing with a colloidal bismuth pectin nominal value of the colloidal bismuth pectin enteric-coated tablet for calculating a dissolution rate.

According to results, the dissolution rates of six colloidal bismuth pectin enteric-coated tablets are respectively 94.2%, 93.2%, 96.3%, 94.8%, 96.5%, and 96.1%; an average value is 95%.

Embodiment 3: colloidal bismuth pectin capsule (50 mg accounted by bismuth) 1) Preparation of a chromogen solution: placing 1 g citric acid and 5 g potassium iodide in a 200 ml volumetric flask; adding 100 ml of water; shaking to dissolve; adding 25 ml of a nitric acid solution of 10 mol/L; adding water to dilute; dripping water to meet a scale, so as to obtain the chromogen solution containing 0.5% of the citric acid and 2.5% of potassium iodide.

2) Preparation of a reference solution of bismuth: placing 275 mg accurately weighed bismuth in a 100 ml volumetric flask; adding 6.4 ml nitric acid to dissolve the bismuth; diluting with water until a scale is reached, so as to obtain a standard bismuth stock solution; weighing 1 ml of the standard bismuth stock solution to place in a 100 ml volumetric flask; diluting with a 1.1 mol/L hydrochloric acid solution until a scale is reached, so as to obtain a solution containing about 27.5 μg bismuth per 1 ml as a standard bismuth solution; accurately weighing 1 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin capsule;

according to a first method (basket apparatus) of dissolution detection in “Pharmacopoeia of the People's Republic of China, 2010 Edition, Volume 2, Appendix XC”, using 1000 ml acetate buffer solution with a pH of 4.0 as dissolution medium, dissolving for 45 min with a rate of 75 r/min, and obtaining dissolution liquid; accurately weighing 5 ml to place in a centrifugal tube; accurately adding 5 ml of 2.2 mol/L hydrochloric acid solution; shaking for 5 minutes; centrifuging for 5 min at 10000 r/min; accurately measuring 1 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 2.2 mol/L hydrochloric acid solution; shaking for 5 minutes; accurately measuring 1 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 399 nm, and calculating the colloidal bismuth pectin content accounted by the bismuth with an external standard method; comparing with a colloidal bismuth pectin nominal value of the colloidal bismuth pectin capsule for calculating a dissolution rate.

According to results, the dissolution rates of six colloidal bismuth pectin capsules are respectively 96.5%, 98.7%, 95.4%, 97.3%, 96.1%, and 94.7%; an average value is 96%.

Embodiment 4: colloidal bismuth pectin colon-enteric-coated capsule (50 mg accounted by bismuth)

1) Preparation of a chromogen solution: placing 20 g ascorbic acid and 20 g potassium iodide in a 200 ml volumetric flask; adding 100 ml of water; shaking to dissolve; adding 50 ml of a nitric acid solution of 2 mol/L; adding water to dilute; dripping water to meet a scale, so as to obtain the chromogen solution containing 10% of the ascorbic acid and 10% of potassium iodide.

2) Preparation of a reference solution of bismuth: placing 275 mg accurately weighed bismuth in a 100 ml volumetric flask; adding 6.4 ml nitric acid to dissolve the bismuth; diluting with water until a scale is reached, so as to obtain a standard bismuth stock solution; weighing 1 ml of the standard bismuth stock solution to place in a 25 ml volumetric flask; diluting with a 0.6 mol/L sulfuric acid solution until a scale is reached, so as to obtain a solution containing about 110 μg bismuth per 1 ml as a standard bismuth solution; accurately weighing 10 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin colon-enteric-coated capsule; according to a third method (cup apparatus) of dissolution detection in “Pharmacopoeia of the People's Republic of China, 2010 Edition, Volume 2,Appendix XC”, using 200 ml sodium borate buffer solution with a pH of 8.5 as dissolution medium, dissolving for 90 min with a rate of 30r/min, and obtaining dissolution liquid; accurately weighing 5 ml to place in a centrifugal tube; accurately adding 5 ml of 1.2 mol/L sulfuric acid solution; shaking for 5 minutes; centrifuging for 15 min at 8000 r/min; accurately measuring 10 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 1.2 mol/L sulfuric acid solution; shaking for 5 minutes; accurately measuring 10 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 433 nm, and calculating the colloidal bismuth pectin content accounted by the bismuth with an external standard method; comparing with a colloidal bismuth pectin nominal value of the colloidal bismuth pectin colon-enteric-coated capsule for calculating a dissolution rate.

According to results, the dissolution rates of six colloidal bismuth pectin colon-enteric-coated capsules are respectively 98.2%, 97.3%, 96.9%, 99.6%, 97.8%, and 99.2%; an average value is 98%.

Embodiment 5: colloidal bismuth pectin powder (50 mg accounted by bismuth)

1) Preparation of a chromogen solution: placing 10 g ascorbic acid and 30 g potassium iodide in a 200 ml volumetric flask; adding 100 ml of water; shaking to dissolve; adding 25 ml of a nitric acid solution of 5 mol/L; adding water to dilute; dripping water to meet a scale, so as to obtain the chromogen solution containing 5% of the ascorbic acid and 15% of potassium iodide.

2) Preparation of a reference solution of bismuth: placing 250 mg accurately weighed bismuth in a 50 ml volumetric flask; adding 6.4 ml nitric acid to dissolve the bismuth; diluting with water until a scale is reached, so as to obtain a standard bismuth stock solution; weighing 1 ml of the standard bismuth stock solution to place in a 50 ml volumetric flask; diluting with a 1.1 mol/L nitric acid solution until a scale is reached, so as to obtain a solution containing about 100 μg bismuth per 1 ml as a standard bismuth solution; accurately weighing 5 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin powder; according to a second method (paddle apparatus) of dissolution detection in “Pharmacopoeia of the People's Republic of China, 2010 Edition, Volume 2, Appendix XC”, using 500 ml phthalate buffer solution with a pH of 5.8 as dissolution medium, dissolving for 120 min with a rate of 30 r/min, and obtaining dissolution liquid; accurately weighing 5 ml to place in a centrifugal tube; accurately adding 5 ml of 2.2 mol/L nitric acid solution; shaking for 5 minutes; centrifuging for 10 min at 10000 r/min; accurately measuring 5 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 2.2 mol/L nitric acid solution; shaking for 5 minutes; accurately measuring 5 ml to place in a 25 ml volumetric flask; diluting with the chromogen solution until a scale is reached, so as to obtain the blank solution.

5) Measuring: taking the reference solution and the test solution of the bismuth;

adopting the blank solution as a reference; applying ultraviolet-visible spectrophotometry, using a 1 cm quartz cuvette, measuring an absorbance at wavelengths of 433 nm and 463 nm, and calculating the colloidal bismuth pectin content accounted by the bismuth with an external standard method according to an absorbance difference at the two wavelengths; comparing with a colloidal bismuth pectin nominal value of the colloidal bismuth pectin powder for calculating a dissolution rate.

According to results, the dissolution rates of six pockets of the colloidal bismuth pectin powder are respectively 95.1%, 99.3%, 97.9%, 96.2%, 95.6%, and 98.3%; an average value is 97%.

Embodiment 6: colloidal bismuth pectin granule (150 mg accounted by bismuth)

1) Preparation of a chromogen solution: placing 5 g ascorbic acid and 40 g potassium iodide in a 200 ml volumetric flask; adding 100 ml of water; shaking to dissolve; adding 25 ml of a nitric acid solution of 2 mol/L; adding water to dilute; dripping water to meet a scale, so as to obtain the chromogen solution containing 2.5% of the ascorbic acid and 20% of potassium iodide.

2) Preparation of a reference solution of bismuth: placing 500 mg accurately weighed bismuth in a 100 ml volumetric flask; adding 6.4 ml nitric acid to dissolve the bismuth; diluting with water until a scale is reached, so as to obtain a standard bismuth stock solution; weighing 1 ml of the standard bismuth stock solution to place in a 50 ml volumetric flask; diluting with a 0.9 mol/L nitric acid solution until a scale is reached, so as to obtain a solution containing about 100 μg bismuth per 1 ml as a standard bismuth solution; accurately weighing 2 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin granule; according to a second method (paddle apparatus) of dissolution detection in “Pharmacopoeia of the People's Republic of China, 2010 Edition, Volume 2, Appendix XC”, using 750 ml 0.01 mol/L hydrochloric solution as dissolution medium, dissolving for 30 min with a rate of 50 r/min, and obtaining dissolution liquid; accurately weighing 5 ml to place in a centrifugal tube; accurately adding 5 ml of 1.8 mol/L nitric acid solution; shaking for 5 minutes; centrifuging for 10 min at 7000 r/min; accurately measuring 2 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 1.8 mol/L nitric acid solution; shaking for 5 minutes; accurately measuring 2 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at wavelengths of 399 nm and 463 nm, and calculating the colloidal bismuth pectin content accounted by the bismuth with an external standard method according to an absorbance difference at the two wavelengths; comparing with a colloidal bismuth pectin nominal value of the colloidal bismuth pectin granule for calculating a dissolution rate.

According to results, the dissolution rates of six colloidal bismuth pectin granules are respectively 93.2%, 94.0%, 92.9%, 96.7%, 94.7%, and 90.6%; an average value is 94%.

Embodiment 7: colloidal bismuth pectin dry suspension (150 mg accounted by bismuth)

1) Preparation of a chromogen solution: placing 8 g ascorbic acid and 50 g potassium iodide in a 200 ml volumetric flask; adding 100 ml of water; shaking to dissolve; adding water to dilute; dripping water to meet a scale, so as to obtain the chromogen solution containing 4% of the ascorbic acid and 25% of potassium iodide.

2) Preparation of a reference solution of bismuth: placing 250 mg accurately weighed bismuth in a 100 ml volumetric flask; adding 6.4 ml nitric acid to dissolve the bismuth; diluting with water until a scale is reached, so as to obtain a standard bismuth stock solution; weighing 5 ml of the standard bismuth stock solution to place in a 25 ml volumetric flask; diluting with a 0.8 mol/L nitric acid solution until a scale is reached, so as to obtain a solution containing about 500 μg bismuth per 1 ml as a standard bismuth solution; accurately weighing 2 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin dry suspension; according to a third method (cup apparatus) of dissolution detection in “Pharmacopoeia of the People's Republic of China, 2010 Edition, Volume 2, Appendix XC”, using 150 ml 0.1 mol/L hydrochloric acid solution as dissolution medium, dissolving for 60 min with a rate of 45 r/min, and obtaining dissolution liquid; accurately weighing 5 ml to place in a centrifugal tube; accurately adding 5 ml of 1.6 mol/L nitric acid solution; shaking for 5 minutes; centrifuging for 15 min at 7000 r/min; accurately measuring 2 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 1.6 mol/L nitric acid solution; shaking for 5 minutes; accurately measuring 2 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 433 nm, and calculating the colloidal bismuth pectin content accounted by the bismuth with an external standard method; comparing with a colloidal bismuth pectin nominal value of the colloidal bismuth pectin dry suspension for calculating a dissolution rate.

According to results, the dissolution rates of six pockets of colloidal bismuth pectin dry suspension are respectively 95.2%, 93.3%, 91.6%, 92.9%, 93.0%, and 90.1%; an average value is 93%.

Embodiment 8: compound colloidal bismuth pectin capsule (comprising colloidal bismuth pectin, metronidazole and tetracycline hydrochloride, wherein 35 mg accounted by bismuth for each capsule)

1) Preparation of a chromogen solution: placing 15 g citric acid and 30 g potassium iodide in a 200 ml volumetric flask; adding 100 ml of water; shaking to dissolve; adding 25 ml of 1 mol/L nitric acid solution; adding water to dilute; dripping water to meet a scale, so as to obtain the chromogen solution containing 7.5% of the citric acid and 15% of potassium iodide.

2) Preparation of a reference solution of bismuth: placing 250 mg accurately weighed bismuth in a 100 ml volumetric flask; adding 6.4 ml nitric acid to dissolve the bismuth; diluting with water until a scale is reached, so as to obtain a standard bismuth stock solution; weighing 3 ml of the standard bismuth stock solution to place in a 100 ml volumetric flask; diluting with a 1.2 mol/L hydrochloric acid solution until a scale is reached, so as to obtain a solution containing about 75 μg bismuth per 1 ml as a standard bismuth solution; accurately weighing 5 ml of the standard bismuth solution to place in a 25 ml volumetric flask; diluting with the chromogen solution until a scale is reached, so as to obtain the reference solution of the bismuth.

3) Preparation of a test solution: taking the compound colloidal bismuth pectin capsule; according to a third method (cup apparatus) of dissolution detection in “Pharmacopoeia of the People's Republic of China, 2010 Edition, Volume 2, Appendix XC”, using 250 ml 0.01 mol/L hydrochloric acid solution as dissolution medium, dissolving for 5 min with a rate of 150 r/min, and obtaining dissolution liquid; accurately weighing 5 ml to place in a centrifugal tube; accurately adding 5 ml of 2.4 mol/L hydrochloric acid solution; shaking for 10 minutes; centrifuging for 12 min at 7000 r/min; accurately measuring 5 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 2.4 mol/L hydrochloric acid solution; shaking for 10 minutes; accurately measuring 5 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 399 nm, and calculating the colloidal bismuth pectin content accounted by the bismuth with an external standard method; comparing with a colloidal bismuth pectin nominal value of the compound colloidal bismuth pectin capsule for calculating a dissolution rate.

According to results, the dissolution rates of six compound colloidal bismuth pectin capsules are respectively 92.3%, 91.6%, 90.9%, 92.1%, 89.6%, and 94.1%; an average value is 92%.

Embodiment 9: detection of dissolution curve of colloidal bismuth pectin capsule (100 mg accounted by bismuth)

1) Preparation of a chromogen solution: placing 5 g ascorbic acid and 25 g potassium iodide in a 200 ml volumetric flask; adding 100 ml of water; shaking to dissolve; adding 25 ml of a nitric acid solution of 1 mol/L; adding water to dilute; dripping water to meet a scale, so as to obtain the chromogen solution containing 2.5% of the ascorbic acid and 12.5% of potassium iodide.

2) Preparation of a reference solution of bismuth: placing 275 mg accurately weighed bismuth in a 100 ml volumetric flask; adding 6.4 ml nitric acid to dissolve the bismuth; diluting with water until a scale is reached, so as to obtain a standard bismuth stock solution; weighing 2 ml of the standard bismuth stock solution to place in a 100 ml volumetric flask; diluting with a 1 mol/L nitric acid solution until a scale is reached, so as to obtain a solution containing about 55 μg bismuth per 1 ml as a standard bismuth solution; accurately weighing 5 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin capsule;

according to a second method (paddle apparatus) of dissolution detection in “Pharmacopoeia of the People's Republic of China, 2010 Edition, Volume 2, Appendix XC”, using 900 ml water as dissolution medium, dissolving for 60 min with a rate of 75 r/min, and obtaining 10 ml dissolution liquid respectively at 10 min, 20 min, 30 min, 45 min and 60 min; accurately weighing 5 ml the dissolution liquid to place in a centrifugal tube; accurately adding 5 ml of 2 mol/L nitric acid solution; shaking and then centrifuging for 10 min at 8000 r/min; accurately measuring 5 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 2 mol/L nitric acid solution; shaking for 10 minutes; accurately measuring 5 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 463 nm, and calculating the colloidal bismuth pectin content accounted by the bismuth with an external standard method; comparing with a colloidal bismuth pectin nominal value of the colloidal bismuth pectin capsule for calculating dissolution rates at different time points for drawing the dissolution curve.

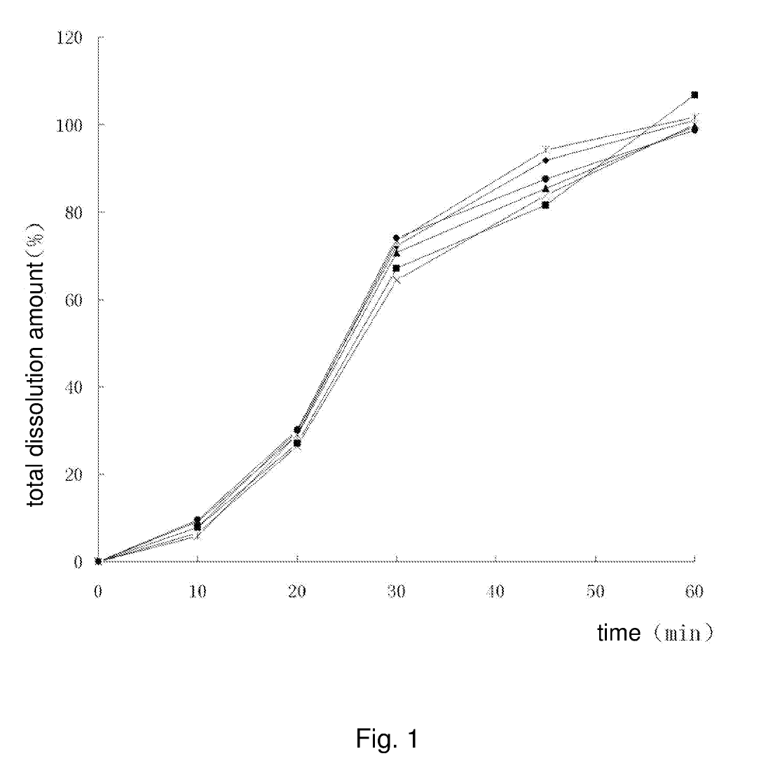

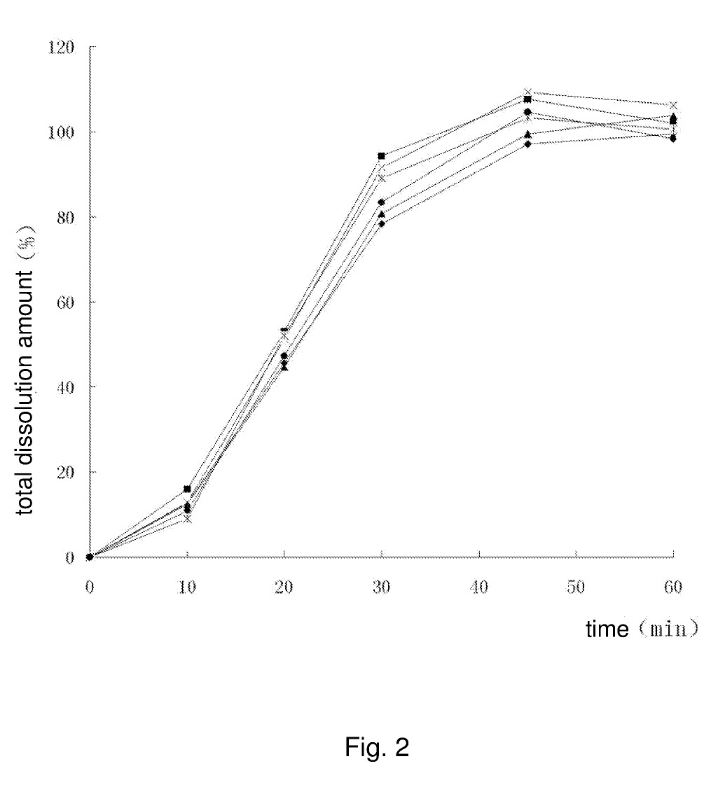

According to results, average dissolution rates of six colloidal bismuth pectin capsules at 10 min, 20 min, 30 min, 45 min and 60 min are respectively 7.8%, 28.5%, 70.3%, 87.4%, and 101.3%; the dissolution curve is shown as FIG. 1.

Embodiment 10: detection of dissolution curve of colloidal bismuth pectin tablet (50 mg accounted by bismuth)

1) Preparation of a chromogen solution: placing 10 g citric acid and 25 g potassium iodide in a 200 ml volumetric flask; adding 100 ml of water; shaking to dissolve; adding 25 ml of a nitric acid solution of 4 mol/L; adding water to dilute; dripping water to meet a scale, so as to obtain the chromogen solution containing 5% of the citric acid and 12.5% of potassium iodide.

2) Preparation of a reference solution of bismuth: placing 275 mg accurately weighed bismuth in a 100 ml volumetric flask; adding 6.4 ml nitric acid to dissolve the bismuth; diluting with water until a scale is reached, so as to obtain a standard bismuth stock solution; weighing 1 ml of the standard bismuth stock solution to place in a 100 ml volumetric flask; diluting with a 1.2 mol/L nitric acid solution until a scale is reached, so as to obtain a solution containing about 27.5 μg bismuth per 1 ml as a standard bismuth solution; accurately weighing 5 ml of the standard bismuth solution to place in a 25 ml volumetric flask; diluting with the chromogen solution until a scale is reached, so as to obtain the reference solution of the bismuth.

3) Preparation of a test solution: taking the colloidal bismuth pectin tablet; according to a first method (basket apparatus) of dissolution detection in “Pharmacopoeia of the People's Republic of China, 2010 Edition, Volume 2, Appendix XC”, using 900 ml phosphate buffer solution with a pH of 6.8 as dissolution medium, dissolving for 60 min with a rate of 100 r/min, and obtaining 10 ml dissolution liquid respectively at 10 min, 20 min, 30 min, 45 min and 60 min; accurately weighing 5 ml the dissolution liquid to place in a centrifugal tube; accurately adding 5 ml of 2.4 mol/L nitric acid solution; shaking and then centrifuging for 5 min at 10000 r/min; accurately measuring 5 ml of supernatant to place in a 25 ml volumetric flask; diluting with the chromogen solution until a scale is reached, so as to obtain the test solution.

4) Preparation of a blank solution: accurately measuring 5 ml water to place in a 15 ml centrifugal tube; accurately adding 5 ml of 2.4 mol/L nitric acid solution; shaking for 5 minutes; accurately measuring 5 ml to place in a 25 ml volumetric flask; diluting with the chromogen solution until a scale is reached, so as to obtain the blank solution.

5) Measuring: taking the reference solution and the test solution of the bismuth; adopting the blank solution as a reference; applying ultraviolet-visible spectrophotometry, using a 1 cm quartz cuvette, measuring an absorbance at a wavelength of 463 nm, and calculating the colloidal bismuth pectin content accounted by the bismuth with an external standard method; comparing with a colloidal bismuth pectin nominal value of the colloidal bismuth pectin tablet for calculating dissolution rates at different time points for drawing the dissolution curve.

According to results, average dissolution rates of six colloidal bismuth pectin capsules at 10 min, 20 min, 30 min, 45 min and 60 min are respectively 12.3%, 48.9%, 86.2%, 103.6%, 101.7%; the dissolution curve is shown as FIG. 2.

What is claimed is:

1. A method for detecting a dissolution rate of a preparation containing colloidal bismuth pectin, comprising steps of: according to “Pharmacopoeia of the People's Republic of China, 2010 Edition, Volume 2, Appendix XC”, dispersing the preparation containing the colloidal bismuth pectin into dissolution medium, dissolving for 3-120 min with a centrifuging rate of 30-150 r/min, and directly obtaining dissolution liquid; adding a protonic acid dissociation agent into the dissolution liquid until a hydrogen ion concentration reaches 0.8-1.2 mol/L; centrifuging after completely dissociation; separating a supernatant; coloring the supernatant by adding a chromogen solution of citric acid or ascorbic acid and potassium iodide to obtain a test solution; testing an absorbance of the test solution at a wavelength of 380-470 nm; comparing the absorbance of the test solution with an absorbance of a reference solution with a known bismuth concentration under same conditions; calculating a dissolution amount, which is accounted by bismuth, of the colloidal bismuth pectin; wherein the dissolution medium is water, a buffer solution with a pH of 1.0-10.0, or an acid solution.

2. The method, as recited in claim 1, wherein the preparation containing the colloidal bismuth pectin is a single preparation or a compound preparation, which comprises tablets, dispersible tablets, enteric-coated tablets, colon-enteric-coated tablets, capsules, soft capsules, enteric-coated capsules, colon-enteric-coated capsules, granules, dripping pills, microcapsules and dry suspension.

3. The method, as recited in claim 1, wherein the buffer solution is an acetate buffer solution, a phthalate buffer solution, a phosphate buffer solution or a borate buffer solution, with a pH of 1.0-10.0.

4. The method, as recited in claim 1, wherein the acid solution is a 0.005-0.1 mol/L hydrochloric acid solution.

5. The method, as recited in claim 1, wherein the dissolution detection method is a basket apparatus, a paddle apparatus or a cup apparatus in the “Pharmacopoeia of the People's Republic of China, Volume 2, Appendix XC”.

6. The method, as recited in claim 1, wherein the protonic acid dissociation agent is nitric acid, hydrochloric acid or sulfuric acid.

7. The method, as recited in claim 1, wherein the chromogen solution is a water solution or a 0.2-2 mol/L nitric acid solution of the potassium iodide, with the citric acid or the ascorbic acid.

8. The method, as recited in claim 7, wherein the chromogen solution comprises the citric acid or the ascorbic acid of 0.5 wt %-10 wt %, and the potassium iodide of 2.5 wt %-25 wt %.

9. The method, as recited in claim 1, wherein the reference solution of the bismuth is prepared by dissolving metal bismuth in nitric acid before being diluted with water and adding the chromogen solution.

10. The method, as recited in claim 1, wherein a bismuth content per 1 ml of the test solution or 1 ml of the reference solution of the bismuth is 0.1-50 μg.

11. The method, as recited in claim 1, wherein the dissolution liquid dissociated with the protonic acid is centrifuged for 5-15 min with a centrifuging rate of 7000-10000 r/min.

12. The method, as recited in claim 1, wherein a single-wavelength method is adopted for measurement with any wavelength of 399 nm, 433 nm and 463 nm; or a double-wavelength method is adopted for measurement with any two wavelengths of 399 nm, 433 nm and 463 nm.
